(19) United States
(12) Patent Application Publication
(10) Pub. No.: US 2021/0266234 A1
(43) Pub. Date: Aug. 26, 2021

(54) Over The Top Access Framework and Distributed NFVI Architecture

(71) Applicant: CenturyLink Intellectual Property LLC, Broomfield, CO (US)

(72) Inventors: Thomas C. Barnett, JR., Monroe, LA (US); Kevin M. McBride, Lone Tree, CO (US)

(21) Appl. No.: 16/896,406

(22) Filed: Jun. 9, 2020

Related U.S. Application Data
(60) Provisional application No. 62/979,196, filed on Feb. 20, 2020.

(51) Int. Cl. H04L 12/24; H04L 29/06; H04L 29/12; H04L 12/911

(52) U.S. Cl. CPC H04L 41/5006; H04L 41/0806; H04L 47/783; H04L 61/2007; H04L 63/104

(57) ABSTRACT

Novel tools and techniques for an OTT access framework and distributed NFVI architecture are provided. A system includes a first user device associated with a first customer, a distribution point unit, a layer 3 switch defining a network edge, a captive portal host located at a central office, a network enhanced gateway located in the central office, the network enhanced gateway coupled to the layer 3 switch, and the captive portal host. The network enhanced gateway is configured to determine, via the captive portal host, one or more services to be provided to the user device, wherein the one or more services includes internet service at a contracted speed, authenticate, via an authentication, authorization, and accounting service, the user device, and establish, via a policy manager, quality of service for ingress traffic to the user device at the distribution point unit according to the contracted service speed.

### CROSS REFERENCE TO RELATED APPLICATIONS

This application claims priority to U.S. Provisional Patent Application Ser. No. 62/979,196, filed Feb. 20, 2020 by Thomas C. Barnett et al., entitled “OVER THE TOP ACCESS FRAMEWORK AND DISTRIBUTED NFVI ARCHITECTURE,” the entire disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to network access and service provisioning, and more particularly to an architecture and scheme for delivering over-the-top access to distributed local resources.

### BACKGROUND

With growing demand for over-the-top (OTT) services and applications, as well as the increasing availability of cloud-based services and resources, consumer demand for 1 gigabit per second (Gbps) or greater bandwidth services has steadily been growing. Moreover, consumers are becoming increasingly mobile, and often want their services available to them wherever they go. Thus, having services only available at a customer's home is often no longer adequate for many customers.

Customer expectations have further shifted to include instantaneous service selection, in which services may be started, adjusted, and stopped through a simple web interface or app. To accommodate the changing demands, server infrastructure and data center functionality has been pushed closer to the customers and distributed across a service provider's network, such as at a central office (CO) or headend. OTT services typically leverage an existing architecture, such as an internet protocol (IP) network, to offer services that bypass traditional distribution channels (e.g., video and voice services). Similarly, traditional phone ordered services with multiple day setup times and scheduled installations are increasingly becoming obsolete. Unlike OTT services, however, a customer's internet service is typically limited to a specific customer premises, and/or customer premises equipment.

Accordingly, tools and techniques providing an OTT access network framework and a distributed network function virtualization infrastructure (NFVI) architecture to support the OTT access framework are provided below.

### BRIEF DESCRIPTION OF THE DRAWINGS

A further understanding of the nature and advantages of the embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic block diagram of a system for implementing an OTT access framework and distributed NFVI architecture, in accordance with various embodiments;

FIG. 2 is a schematic diagram of a model VLAN data plane, in accordance with various embodiments;

FIG. 3A is a sequence diagram for account creation utilizing an OTT access framework and distributed NFVI architecture, in accordance with various embodiments;

FIG. 3B is a sequence diagram for adding a new device utilizing an OTT access framework and distributed NFVI architecture, in accordance with various embodiments;

FIG. 3C is a sequence diagram for DPU authentication, in accordance with various embodiments;

FIG. 3D is a sequence diagram of a DHCP handshake for DPUs, in accordance with various embodiments;

FIG. 4 is a flow diagram of a method for an OTT access framework in a distributed NFVI architecture;

FIG. 5 is a flow diagram of a method for a composable network using distributed NFVI architecture;

FIG. 6 is a schematic block diagram of a computer system providing OTT access to network services, in accordance with various embodiments; and

FIG. 7 is a block diagram illustrating a networked system of computing systems, which may be used in accordance with various embodiments.

### DETAILED DESCRIPTION OF CERTAIN EMBODIMENTS

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

The various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible, and/or non-transitory computer readable media (such as, to name but a few examples, optical media, magnetic media, and/or the like).

In an aspect, a system for implementing an OTT access framework and distributed NFVI architecture is provided. The system includes a first user device associated with a first customer, a distribution point unit, a layer 3 switch defining a network edge, a captive portal host located at a central office, and a network enhanced gateway located in the central office, the network enhanced gateway coupled to the layer 3 switch, and the captive portal host. The distribution point unit may be configured to couple the user device to the layer 3 switch, wherein the layer 3 switch is configured to couple the distribution point unit to the network enhanced gateway. The network enhanced gateway may include a processor, and non-transitory computer readable media comprising instructions executable by the processor to implement the OTT access framework and distributed NFVI architecture. The instructions may be executed by the processor to receive, via the layer 3 switch, a request for an internet protocol address from the user device, determine whether the user device is a known device, assign a first internet protocol address to the user device, and direct user packets from the user device to the captive portal host. The instructions may further be executed by the processor to determine, via the captive portal host, one or more services to be provided to the user device, wherein the one or more services includes internet service at a contracted speed, and authenticate, via an authentication, authorization, and accounting service, the user device. The processor may further execute instructions to establish, via a policy manager, quality of service for ingress traffic to the user device at the distribution point unit according to the contracted service speed.

In another aspect, an apparatus for implementing an OTT access framework and distributed NFVI architecture is provided. The apparatus may include a processor, and non-transitory computer readable media comprising instructions executable by the processor to receive, via a layer 3 switch, a request for an internet protocol address from a user device, determine whether the user device is a known device, assign a first internet protocol address to the user device, and direct user packets from the user device to a captive portal. The processor may further execute the instructions to determine, via the captive portal, one or more services to be provided to the user device, wherein the one or more services includes internet service at a contracted speed, and authenticate, via an authentication, authorization, and accounting service, the user device. The instructions may further be executable by the processor to establish, via a policy manager, quality of service for ingress traffic to the user device at a distribution point unit according to the contracted service speed.

In a further aspect, a method for implementing an OTT access framework and distributed NFVI architecture is provided. The method includes receiving, via a layer 3 switch, a request for an internet protocol address from a user device, determining, via a network enhanced gateway, whether the user device is a known device, assigning, via the network enhanced gateway, a first internet protocol address to the user device, and directing, via the network enhanced gateway, user packets from the user device to a captive portal. The method further includes determining, via the captive portal, one or more services to be provided to the user device, wherein the one or more services includes internet service at a contracted speed, and authenticating, via an authentication, authorization, and accounting service, the user device. The method continues by establishing, via a policy manager, quality of service for ingress traffic to the user device at a distribution point unit according to the contracted service speed.

Various modifications and additions can be made to the embodiments discussed without departing from the scope of the invention. For example, while the embodiments described above refer to specific features, the scope of this invention also includes embodiments having different combination of features and embodiments that do not include all the above described features.

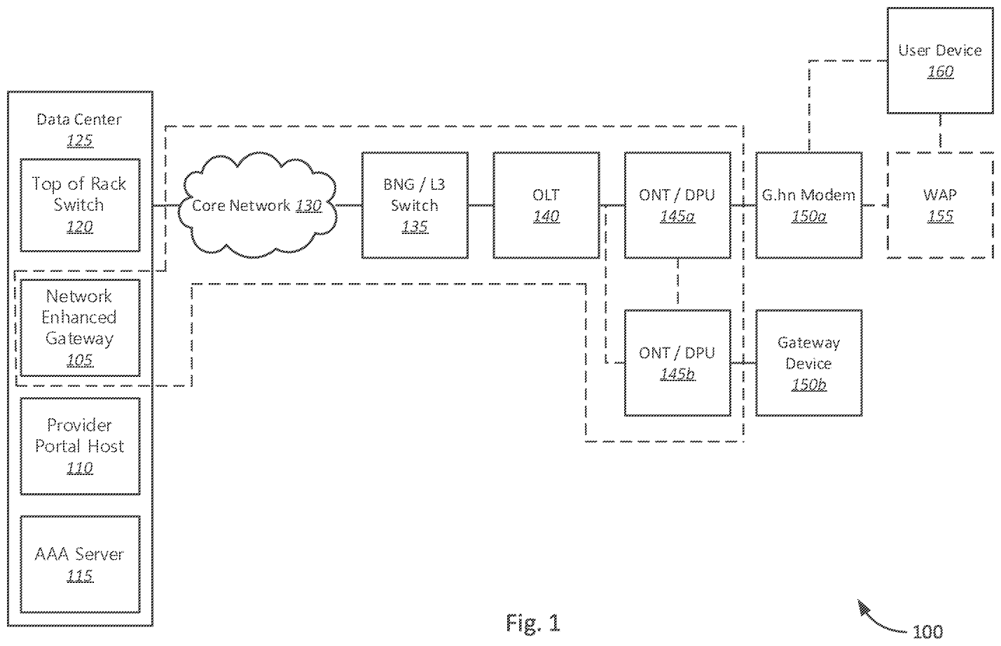

FIG. 1 is a schematic block diagram of a system 100 for implementing an OTT access framework and distributed NFVI architecture, in accordance with various embodiments. The system 100 includes a data center 125, which includes a network enhanced gateway (NEG) 105, provider portal host 110, AAA server 115, and top of rack switch (TOR) 120. The system 100 further includes a core network 130, layer 3 (L3) switch 135, optical line termination 140, distribution point units (DPUs) 145 including a first DPU 145a and second DPU 145b, gateway device 150 including a first G.hn modem 150a and a gateway device 150b, wireless access point (WAP) 155, and user device 160. It should be noted that the various components of the system 100 are schematically illustrated in FIG. 1, and that modifications to the system 100 may be possible in accordance with various embodiments.

In various embodiments, the data center 125 may include the NEG 105, provider portal host 110, AAA server 115, and a TOR 120. The NEG 105 may be coupled to the L3 switch 135 via the core network 130. The L3 switch 135 may be coupled to the OLT 140, which may in turn be coupled to one or more DPUs 145a-145b. The first DPU 145a may be coupled to the first G.hn modem 150a, and the second DPU 145b may be coupled to the gateway device 150b. The first G.hn modem 150a may be coupled to the WAP 155, to which the user device 160 may be coupled. Alternatively, the user device 160 may be coupled directly to the G.hn modem 150a, or via a router, switch, or other access point (AP), as known to those skilled in the art.

In various embodiments, the data center 125 may include, or otherwise be located physically at, a central office (CO), cable headend, telco exchange, or other facility controlled by a service provider. The data center 125 may include a NEG 105 configured to provide authentication, authorization, and accounting (AAA), dynamic host configuration protocol (DHCP), network address translation (NAT), subscriber management, and subscriber experience management. In some embodiments, the service provider may control both the NEG 105 and the data center 125. In some embodiments, the service provider that controls the data center may be a third-party service provider different from a service provider associated with the NEG 105. In some embodiments, the service provider associated with the NEG 105 may be a third-party service provider and placed at a data center controlled by the service provider. Accordingly, a data center controlled by one service provider may be configured to host one or more NEGs 105 associated with one or more respective service providers.

The NEG 105 may be configured to provide access node and subscriber management capabilities. The NEG 105 may further be configured to provide user devices, such as user device 160, access to one or more respective services, which a respective user of the user device 160 is authorized to receive. Accordingly, an example topology configured to provide such an arrangement is provided by system 100. In some embodiments, the system 100 may be based on a standard TR-101 access network model, with the addition of one or more DPUs 145, such as DPUs 145a-145b. The DPUs 145 may, in some embodiments, be one or more of a switch and optical network terminal (ONT). The DPU 145a-145b may include, in some examples, an Ethernet switch with a plurality of enhanced small form-factor pluggable (SFP+) sockets, with one of the SFP+ sockets configured to be a trunk port while the remaining SFP+ sockets are configured to be access ports. In some examples, the SFP+ access ports can be configured to host Ethernet, passive optical network (PON), G.hn or G.fast SFP+ modules, but configured to interfaced with the DPU as Ethernet ports of variable speed. DPUs 145 are described in further detail with reference to U.S. patent application Ser. No. 16/446,428, which is hereby incorporated by reference in its entirety for all purposes.

To allow network access to a user device 160, in various embodiments, the user device 160 may be configured to be coupled to the NEG 105. The NEG 105, therefore, may be configured to be coupled to the user device 160 via a respective DPU 145a-145b, OLT 140, and L3 switch 135. When the user device 160 first connects to the NEG 105, traffic from the user device 160 may first be transmitted to the DPU 145, in this case the first DPU 145a. In some embodiments, the DPUs may be coupled to the NEG 105 via a layer 2 (L2) tunnel, also referred to as an Ethernet over IP (EoIP) tunnel, such as a generic routing encapsulation (GRE) tunnel to the NEG 105. This provides an L2 path over intervening network elements, such as the ONT, OLT, and L3 switch 135. For example, in some embodiments, the L3 switch 135 may include, without limitation, a border network gateway (BNG). In some embodiments, the DPUs 145 may be configured to act as an ONT. Thus, in some examples, the first DPU 145a may include an ONT coupled to the OLT 140. The L2 tunnel, accordingly, is depicted in the dashed box, extending from the NEG 105 to the DPUs 145.

In some embodiments, the customer premises, via which the user device 160 couples to the NEG 105, may not include a residential gateway. In the event a residential gateway, wireless access point (WAP), or home router is present at the customer premises, the NEG 105 may be configured to assign the residential gateway, WAP 155, or home router with a public address.

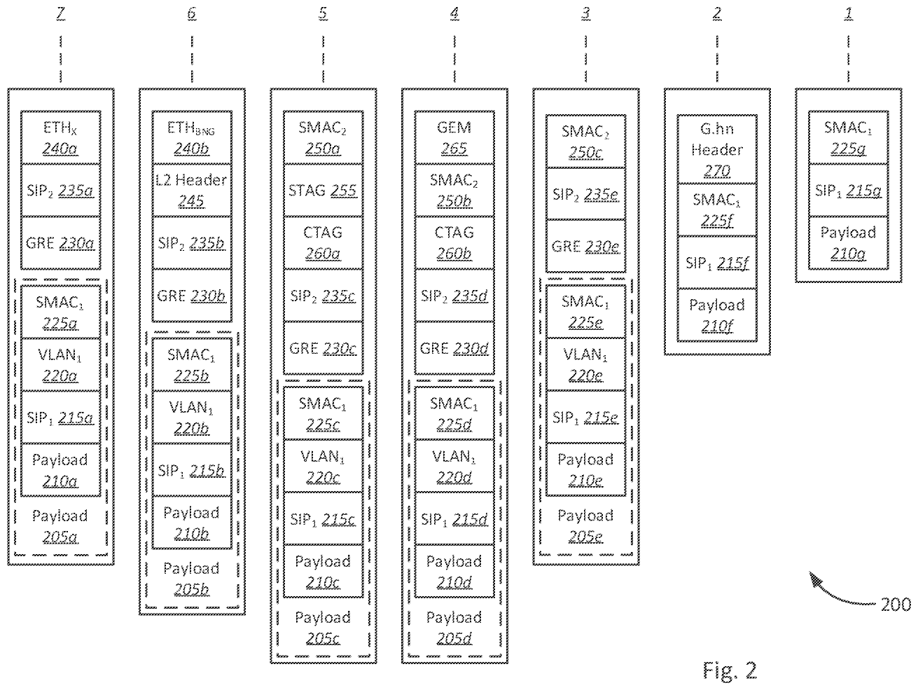

Accordingly, with reference to FIG. 2, data from (upstream) and to (downstream) the user device 160 may be handled as follows. FIG. 2 is a schematic diagram of a model VLAN data plane 200, in accordance with various embodiments. The model VLAN data plane 200 depicts the various states of a packet as it traverses between the NEG 105 and user device 160. It should be noted that the various stages of the model VLAN data plane 200 are schematically illustrated in FIG. 2, and that modifications to the model VLAN data plane may be possible in accordance with various embodiments.

Gateway devices 150 may include, without limitation, a modem (such as a the first G.hn modem 150a), a network interface device (NID), such as a Metro Ethernet Forum 2.0 (MEF-2.0) NID, or any other L2 business and/or residential gateway (RG). Although various embodiments are described with reference to the first G.hn modem 150a, it is to be understood that in other examples, other types of L2 gateways may be used in place of the first G.hn modem 150a.

Thus, in some embodiments, upstream subscriber traffic may be carried untagged across the WAP 155 and a respective gateway device 150. Accordingly, in some examples, upstream subscriber traffic may be transmitted to the first G.hn modem 150a, towards the respective DPU 145, such as the first DPU 145a. For example, over a first segment (segment 1), between the user device 160 and the G.hn modem 150a, a frame generated by the user device 160 may include a source device media access control (MAC) address (SMAC₁) 225g header, a source device IP address (SIP₁) 215g header, the source device IP address being assigned the user device 160 by the NEG 105, and payload data 210g. The G.hn modem 160a may add a source G.hn device identifier in G.hn header 270 to the rest of the payload data. Accordingly, the frame, at segment 2, may include G.hn header 270, SMAC₁ 225f, SIP₁ 315f, and payload data 210f.

In various embodiments, once the first DPU 145a receives the respective data frame from the first G.hn modem 150a, the DPU may be configured to assign a VLAN tag to the packet, based on a port of arrival, and forward the frame to a respective ONT SFP in an untagged L2 tunnel (such as the GRE tunnel described earlier). Accordingly, in some embodiments, the DPU 145a may be configured to decapsulate the frame and encapsulate each of SMAC₁ 325e, a per-port VLAN tag (VLAN₁) 320e added by the DPU, SIP₁ 315e, and payload data 310e as an encapsulated payload 305e. Accordingly, the DPU may be configured to assign a VLAN tag, VLAN₁ 320e, identifying respective individual customer VLANs coupled to the first DPU 145a. The first DPU 145a may further be configured to add to the Ethernet frame a generic routing encapsulation (GRE) packet header, GRE 230e, GRE tunnel source IP assigned to the DPU SIP₂ 235e, and a DPU source MAC address SMAC₂ 250c. Accordingly, a frame at the network segment between the DPU and ONT (segment 3) may include SMAC₂ 250c, SIP₂ 235e, GRE 230e, and encapsulated payload 205e, which further includes SMAC₁ 225e, VLAN₁ 220e, SIP₁ 215e, and payload data 210e.

In various embodiments, the ONT of a respective DPU 145a may be configured to encapsulate the Ethernet frame, at segment 3, into a GPON encapsulation method (GEM) frame as known to those in the art. Accordingly, the ONT may be configured to push a GPON encapsulation method (GEM) header 265, and a customer VLAN tag (CTAG) 260b to the frame. Thus, in some examples, the CTAG 260b may identify a VLAN tag associated with a given DPU as opposed to a specific customer VLAN. Accordingly, the frame, at segment 4 between the ONT and OLT, may include GEM 265, SMAC₂ 250b, CTAG 260b, SIP₂ 235d, GRE 230d, and encapsulated payload 205d, which further includes SMAC₁ 225d, VLAN₁ 220d, SIP₁ 215d, and payload data 210d. The ONT may, thus, forward the frame upstream to the OLT 140.

The OLT 140, in various embodiments, may terminate the GPON transmission convergence (GTC) layer, and may be coupled to the L3 switch 135 (e.g., a BNG). Although a direct connection is shown between the OLT 140 and the L3 switch 135, is will be understood by those skilled in the art that varying L2 network infrastructure may be present between the OLT 140 and the L3 switch 135 (e.g., BNG). In various embodiments, the STAG 255 may be configured to identify the service VLAN of the service provider. In some examples, tagging with both a CTAG 260a and STAG 255 be referred to as a double tagged VLAN. Accordingly, in some embodiments, the OLT 140 may be configured to push on a service VLAN tag (STAG) 255 of the service provider to the frame, resulting in a double tagged (QinQ/1:1 VLAN) frame, and forwards the frame upstream to the L3 switch (e.g., the BNG). In some embodiments, the STAG 255 may be translated from one or more of the CTAG 260b and/or GEM header 265. Accordingly, the frame at segment 5, between the OLT 140 and the L3 switch 135 may include SMAC₂ 250a, STAG 255, CTAG 260a, SIP₂ 235c, GRE 230c, and encapsulated payload 205c, which further includes SMAC₁ 225c, VLAN₁ 220c, SIP₁ 215c, and payload data 210c.

The L3 switch 135 may, in turn, be configured to push a BNG source MAC address (ETH_{BNG}) 250b, and layer 2 (L2) header 245 onto the frame. In some embodiments, the L3 switch 135 may be configured to perform QoS enforcement and management (on a per-tunnel basis) and forward the frame upstream to the NEG 105. In various embodiments, the structure of the L2 header 245 may vary depending on the organization of the core network 130. For example, if the core network 130 uses multiprotocol label switching (MPLS), and MPLS header may be added by the BNG 230. If an VXLAN or VLAN configuration is utilized by the core network 130, appropriate VXLAN or VLAN header may be added by the BNG 230. Accordingly, the frame at segment 6, between the L3 switch 135 and core network 130 may include ETH_{BNG} 250b, L2 header 245, SIP₂ 235b, GRE 230b, and encapsulated payload 205b, which further includes SMAC₁ 225b, VLAN₁ 220b, SIP₁ 215b, and payload data 210b.

Depending on the organization of the core network 130, when the frame arrives at data center 125, and is received by the NEG 105, as depicted at segment 7. Accordingly, the frame may include ETH_{X} 240a, which is the last/most recent source MAC address that is on the frame when it arrives from the core network 235. The frame further includes SIP₂ 235a, GRE 230a, and encapsulated payload 205a, which further includes SMAC₁ 225a, VLAN₁ 220a, SIP₁ 215a, and payload data 210a. The NEG 105 may, in turn, route the data as from the data center 125 to the appropriate service provider's cloud network and/or resources, and/or to the appropriate recipient. For example, in various embodiments, the NEG 105 may be configured to receive the L2 tunnel traffic (e.g., EoIP/GRE tunnel traffic), decapsulate the data, and process the packet accordingly taking its respective tags into account. In this way, data is appropriately routed from and to the appropriate user device 160 on a respective customer VLAN, as assigned by the NEG 105.

In the downstream direction, in various embodiments, the NEG 105 may be configured to forward a packet towards a subscriber (e.g., the user device 160). The packet has the appropriate VLAN tag pushed on, and then the packet is encapsulated into an L2 tunnel (e.g., an EoIP/GRE tunnel) with a destination IP address of the DPU 145a. The NEG 105 may forward the packet to an L3 switch 135, such as a BNG. The L3 switch 135 may then route the frame to the OLT 140, pushing a new Ethernet header with STAG 255 and CTAG 260a onto the frame.

The OLT 140 may receive the frame from the L3 switch 135, and remove the STAG, and forward the frame via the L2 tunnel to the ONT and/or DPU 145. The ONT may remove the CTAG 260b, and L2 forward the frame to the respective first DPU 145a. The DPU 145a may remove the L2 tunnel header (e.g., GRE header 230e), and forward it to the appropriate access port associated with the visible VLAN tag 220e. The access port may remove the VLAN tag 220e and forward the frame via the L2 tunnel to the respective G.hn modem 150a, and on to the respective user device 160.

In some alternative embodiments, the DPUs 145a, 145b may be daisy chained together, such that traffic may be passed between upstream and downstream DPUs. For example, the first DPU 145a may be an upstream DPU, and coupled to the OLT 140. The second DPU 145b may be a downstream DPU coupled to the first DPU 145a. In the case of upstream traffic forwarded from the downstream second DPU 145b, in some embodiments, the second DPU 145b may be configured to assign a VLAN tag to the packet based on the port of arrival on the second DPU 145b, and forward the packet to the downstream DPU, in this case the first DPU 145a, in an untagged L2 tunnel. The first DPU 145a may be configured to receive the untagged frame and forward it on to the ONT, for further processing. Accordingly, the upstream DPU (e.g., first DPU 145a) may be configured to place a packet received from a downstream DPU (e.g., the second DPU 145b) into a separate daisy-chain queue for forwarding further downstream, in this case onto a respective ONT. For example, in some embodiments, a respective upstream DPU may include a dedicated backhaul port for backhauling traffic received from downstream DPUs.

In downstream operation, the NEG 105 may be configured to a tag a packet with an appropriate VLAN and encapsulated into an L2 tunnel with a destination IP address of a downstream DPU (e.g., the second DPU 145b). Accordingly, the upstream DPU (e.g., first DPU 145a) may be configured to recognize a packet as not being addressed to the first DPU 145a and forward the packet onto a downstream DPU (e.g., the second DPU 145b). As previously described in the upstream example, in some embodiments, an upstream DPU may include a daisy-chain port configured to forward packets that are addressed to downstream DPUs. In some embodiments, the backhaul port and daisy chain port may be a bi-directional port carrying both upstream and downstream traffic between DPUs 145.

In various embodiments, when the user device 160 first connects to the NEG 105, the NEG 105 may be configured to forward traffic received from the user device 160 to a provider portal host 110. In some embodiments, the user device 160 may be associated with a new user, and a new account may be created for the new user. In some embodiments, the user device 160 may be associated with an existing user and may be a new device from which the user is accessing the services. Alternatively, the user device 160 may be a guest device requesting access as a guest of an existing user.

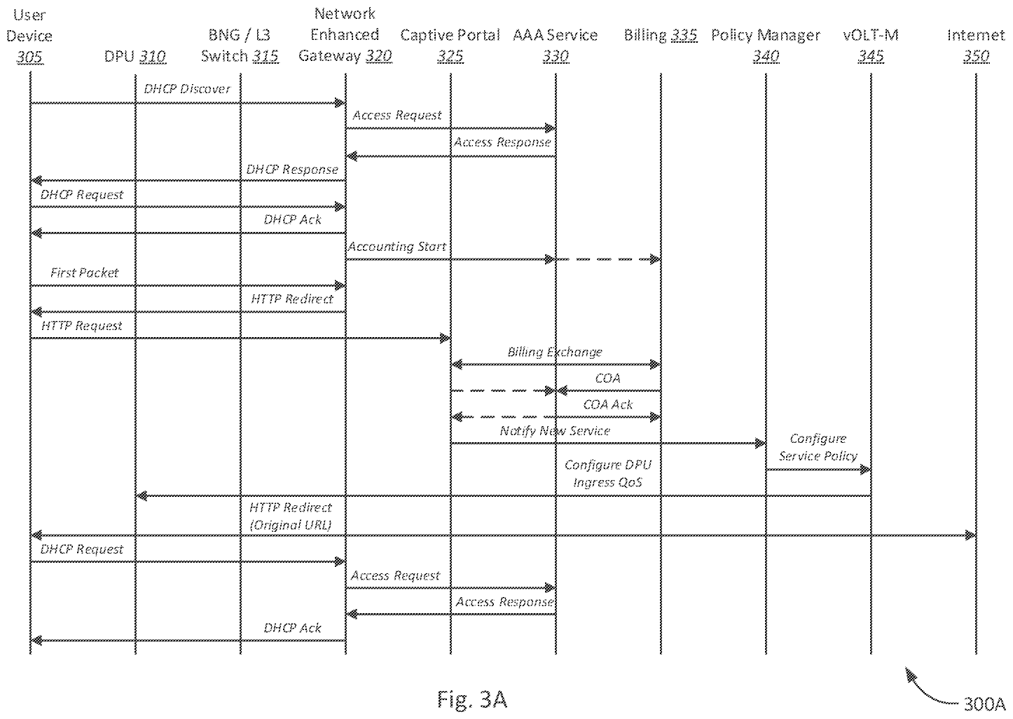

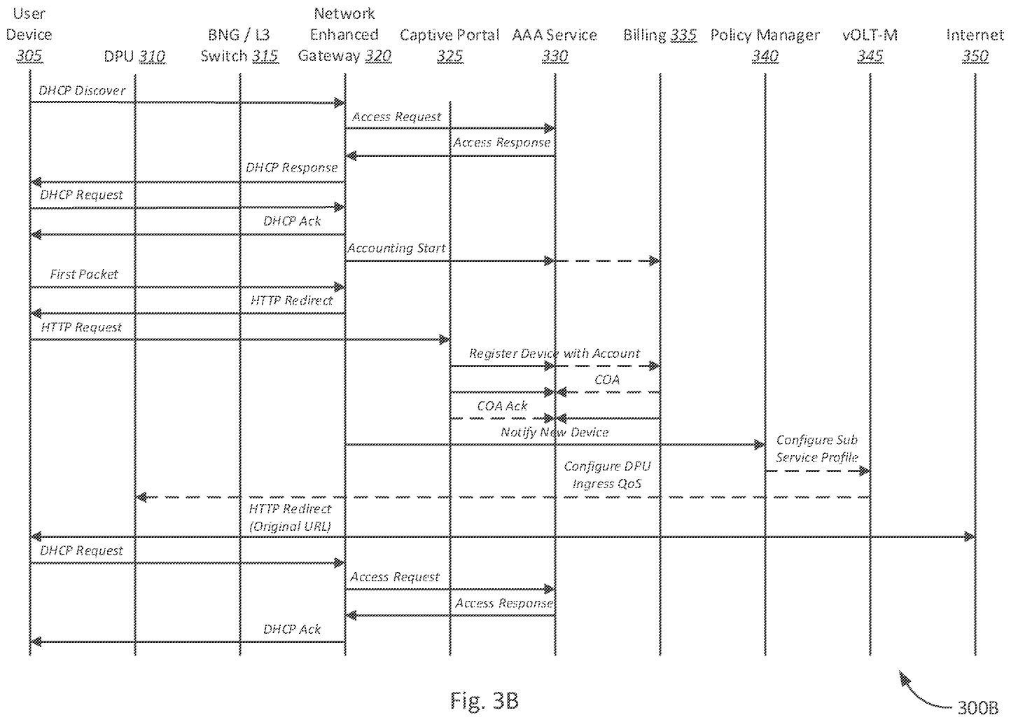

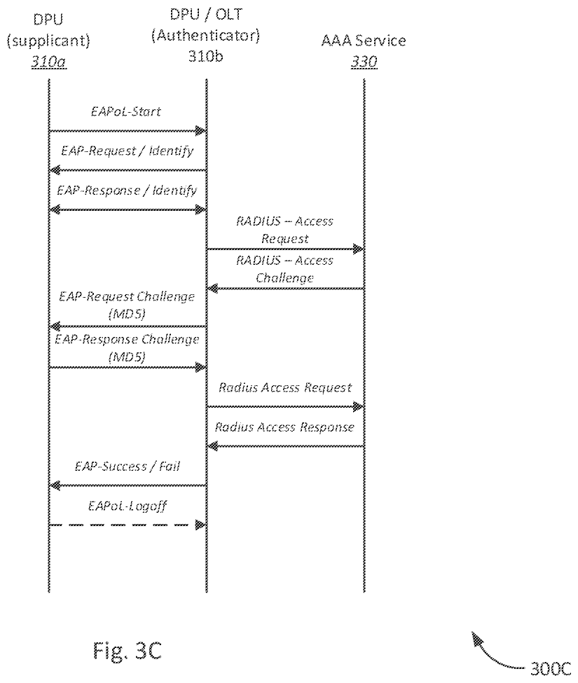

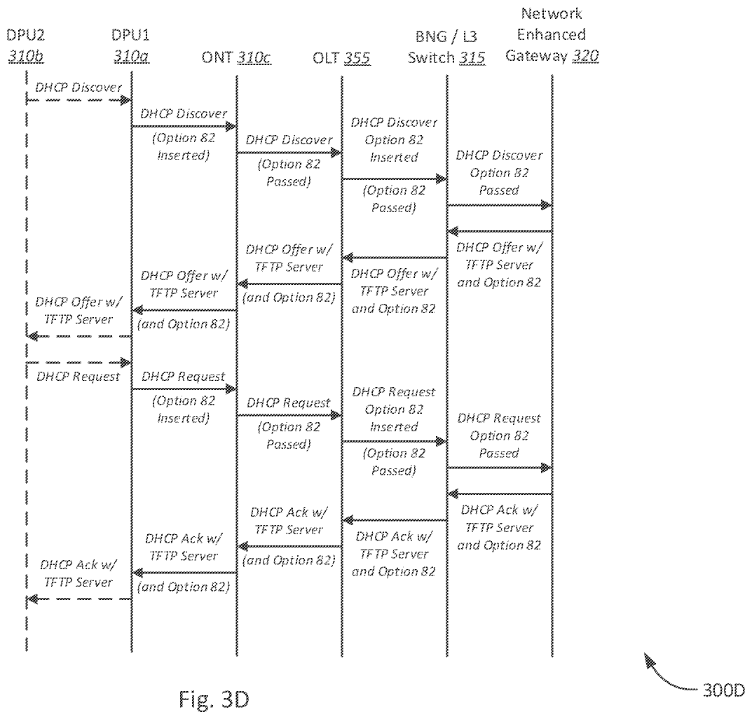

Accordingly, with reference to FIGS. 3A & 3B, the NEG 105 may be configured to handle access attempts from a user device 160 according to whether an associated user is a new user or existing user. FIG. 3A is a sequence diagram for account creation 300A utilizing an OTT access framework and distributed NFVI architecture, in accordance with various embodiments. The account creation sequence diagram 300A includes user device 305, DPU 310, BNG/L3 switch 315, NEG 320, Captive Portal 325, AAA service 330, billing service 335, policy manager 340, vOLT-M 345, and the Internet 350. It should be noted that the various components of the sequence diagram 300A are schematically illustrated in FIG. 3A, and that modifications to the components of the sequence diagram 300A may be possible in accordance with various embodiments.

In various embodiments, a user may connect a user device 160, 305 for the first time to a local WiFi network via the WAP 155, or plug into a network via a physical line. Thus, the user device 305 may be configured to request an IP address from a DHCP server, in this case a DHCP service provided the NEG 320. Accordingly, the user device 305 may be configured to transmit a DHCP discover message, which may be received by the NEG 320. The NEG 320 may be configured to transmit an access request to an AAA service 330. In some embodiments, the AAA service 330 may be provided by a AAA server. In some embodiments, the NEG 320 may be configured to provide the AAA service 330. The access request may include an identifier associated with the user device 305, such as a username, serial number, hardware address, or other identifier associated with a user and/or user device 305. In the case that a user device 305 is not a known device, as in this example, the access request may include an identifier, or an indication that the user device 305 is not a known by the NEG 320. The AAA service 330 may be configured to authenticate the user and/or user device 305 based on the access request. If it is determined that the user device 305 is not known, the AAA service 330 may be configured to generate an access response indicating that the user device 305 should be redirected to a captive portal 325. For example, in some embodiments, the access response may include a URL of the captive portal 325 to which the user device 305 is redirected.

Continuing with the example that the user device 305 is not a known device, once the access response is received, the NEG 320 may be configured to issue a temporary IP address via DHCP. As known to those skilled in the art, one example of a DHCP handshake is described. In some embodiments, a temporary IP address may be an address in a guest subnet with a short time lease. For example, the user may be given an IP address in a different subnet after authentication or keep their address but with a longer lease time after authentication. Distinctions between various subnets is described in greater detail in embodiments described below. Accordingly, the NEG 320 may be configured to transmit a DHCP response to the user device 305, responsive to the DHCP discover message. The DHCP response may include, for example, a DHCP offer configured to indicate the temporary IP address for use by the user device 305. The user device 305 may be configured to respond to the DHCP response with a DHCP request configured to indicate requesting to use the indicated temporary IP address. The NEG 320 may respond with a DHCP Ack message, confirming that the client has been given a lease on the temporary IP address.

Once the temporary IP address has been issued to the user device 305, data (e.g., data packets) from the user device 305 are received by the NEG 320. The NEG 320 may be configured to redirect the user device 305 towards the captive portal 325. Accordingly, the NEG 320 may be configured to receive a first packet from the user device 305. The NEG 320 may transmit an HTTP redirect response to the user device 305 in response to the first packet. In response, the user device 305 may be configured to connect to the captive portal by transmitting an HTTP request to the captive portal 325. are received by the NEG which redirects the device towards the captive portal.

Accordingly, in various embodiments, communications may be established between the user device 305 and the captive portal 325. The user may, in some embodiments, further interact with the captive portal 325 to create an account, and to select and configure services. In this way, a user may be able to nearly instantaneously, and in near real-time, select and configure services as desired. Once service have been selected, the captive portal 325 may interface with a billing system to setup and process payment and a billing account. The user interacts with the captive portal, completing various transactions to set up their services. Thus, the billing exchange may take place between the captive portal 325 and the billing service 335. In some embodiments, the billing service 335 may be hosted on one or more servers of a billing system. In some embodiments, the NEG 320 may be configured to further provide the billing service 335.

In various embodiments, the billing service 335 and/or captive portal 325 may be configured to update the AAA service 330, which may in turn update the NEG 320. Accordingly, in some embodiments, the billing service 335 may be configured to transmit a remote authentication dial-in user service (RADIUS) change of authorization (COA) to the AAA service 330, which may respond with a COA acknowledgment, indicating that the user device 305 is now authenticated. In some embodiments, the AAA service 330 may further update the NEG 320 indicating that the user device 305 is now an authorized device.

In various embodiments, the NEG 320 may be configured to notify a policy manager 340 of the new services. In some embodiments, the NEG 320 may transmit the identity and location of the user device 305 and/or user and identify the selected services to be provided to the user device 305. In response, the policy manager 340 may be configured to configure services and/or connections according to a service policy, or as indicated by the services selected and configured by the user via the captive portal 325. For example, in some embodiments, the policy manager 340 may be configured to cause changes to the network (e.g., via an OLT and/or at the ONT/DPU 310) to provide a service to the user device 305 according to selections made in the captive portal. In some examples, the vOLT-M may be configured to provision service speed according to a service policy associated with the user and/or selected services. In some embodiments, a virtualized OLT manager (vOLT-M) 345 may be configured to manage ingress quality of service (QoS) at the OLT and respective DPUs 310 servicing the user device 305. Thus, user device 305 may receive service, and traffic from the user device 305 may now be redirected to the original URL via the internet 350.

In some embodiments, shortly after receiving service, the user device 305 may be configured to renew its respective DHCP lease and/or request a new IP address. Accordingly, the user device 305 may be configured to transmit a new DHCP request to the NEG 320. The NEG 320 may then transmit an access request to the AAA service 330, which now recognizes the identifier associated with the user device 305, and may provide an access response authorizing the user device to be provided with a new IP address, or to renew the DHCP lease. In some embodiments, the new IP address may further be assigned to the appropriate subnet for their service policy by the NEG 320.

FIG. 3B is a variation on the OTT access framework of 300A. FIG. 3B is a sequence diagram for adding a new device 300B utilizing an OTT access framework and distributed NFVI architecture, in accordance with various embodiments. Like in sequence diagram 300A, when a new user device 305 attempts to access a network and/or network services, the user device 305 broadcasts a DHCP discover message, which may then be received by the NEG 320. The NEG 320 may respond by transmitting an access request to the AAA service 330, which may not recognize the new user device 305. The NEG 320 may then receive an access response, indicating that the user device 305 should be redirected to the captive portal 325. The NEG 320 may then provide a DHCP response with a temporary IP address. The user device 305 may then respond with a DHCP request, requesting to use the temporary IP address, and the NEG 320 may respond with a DHCP Ack response. Accounting may then be started at the AAA service 330 and/or billing service 335.

As with new account creation, the NEG 320 may be configured forward all traffic from the user device 305 to the NEG. Thus, the NEG 320 may respond to a first packet with an HTTP redirect. The user device 305 may then be sent to the captive portal 325. The user device 305 may, for example, send an HTTP request to the captive portal 325. Once in the captive portal 325, the user of the user device 305 may log into an account associated with the user and add the new user device 305 to their account. For example, in some embodiments, the captive portal 325 may be configured to prompt a user for a username and password. In this way, additional devices may be associated with a user/user account. The captive portal 325 may then register the device with the account at the billing service 335 and/or update the AAA service 330.

In some embodiments, the captive portal 325 may be configured to update the AAA service 330 by transmitting a COA, to which the AAA service 335 may respond with a COA ack. In some embodiments, the billing service 335 may further be configured to transmit a COA to the AAA service 335, to which the AAA service 335 may respond with a COA ack. The NEG 320 may further be configured to notify the policy manager 340 of the new user device 305. The policy manager 340 may, in turn, be configured to configure the ingress QoS of the DPU 310. For example, the new user device 305 may now be considered part of the existing subscriber's group. In some embodiments, the user device 305 may inherit an existing default policy, which may define a service speed and group to which user device is assigned. The user device 305 may, subsequently, renew its IP address or obtain a new IP address, and may be moved to the appropriate group subnet by the NEG 320.

In another example, the user device 305 may be a guest device, associated with a third-party, but authorized by the user to use the user's services. Accordingly, in various embodiments, the guest user device 305 may similarly be configured to connect to a WAP, through which to access the Internet 350. As previously described, the guest user device 305 may similarly not be recognized by the NEG 320/AAA service 330, and provided initially with a temporary IP address, and redirected towards the captive portal 325. The guest user device 305 may log into the user's guest account via the captive portal 325. In some embodiments, the user's guest account may include a respective set of credentials, such as a username and password combination. In other embodiments, a user's credentials may be used to log into the user's account, and an option may be presented to indicate the user device 305 as a guest device. Thus, by logging in via the captive portal 325, the guest user device 305 may be added to a user's account and/or guest account.

As previously described, the captive portal 325 and/or billing service 335 may be configured to update the AAA service 330 and NEG 320. In some embodiments, the user device 305 may further be added to a user's guest group, and an existing default policy for the guest group may be applied to the user device 305. The policy manager 345 may, accordingly, further configure a respective DPU 310 with an ingress QoS according to the default policy assigned to the guest user device 305. The user device 305 may be configured to renew its temporary IP address, which may already be part of the guest subnet, and/or obtain a new IP address which is in the guest subnet.

In various embodiments, within a given location, there may be multiple groups of traffic. Each group may have its own respective policies. Groups configured via the NEG 105 allow customers to define sets of devices that relate to each other, and define one or more services, or a respective set of services, that may be supported within each respective group. In some embodiments, groups may be subsets, supersets, or share only some devices. A group can have devices as members that also have privileges in other groups for other designated members.

In one example, the “family” group may be a commonly used group by users. When a customer signs up for Internet service, they may register all devices in their home as a part of the family group. All the members of the family group may be configured to have access to all the devices in the home, including printers, files, media content, etc. The family group also allows members and/or member devices of the group to travel and still have access to these resources.

The Guest Group is also a common group. The guest group setup by the customers and allows them to host “guest” devices in their home and restrict guest device access to only the internet. This may, for example, protect a user household resources from being accessed by guests. In some further embodiments, the guest group may have a policy that blocks guests from direct communication with other guests, while allowing the guest internet access. Thus, the guest group may be considered a subset of the family group with different permissions and/or service policies. In yet further embodiments, members of the guest group may be configured to have a selective access to services. For example, in some embodiments, devices within a group may have restricted bandwidth, service speed, or restricted access to services such as streaming music and video.

In some embodiments, another group may be a supergroup. In one example, a supergroup may be an “extended family” group. It is not uncommon to have large extended families where 1 or 2 of the members act as the IT team for all the other families. In some embodiments, by creating an extended family group, the designated members of the extended family group may be part of a smaller group, such as an admin group, with access to all the devices in all the family's homes. Another value of the extended family group is the ability to share resources between different family groups. Thus, in some examples, photos and videos may be displayed in one home from another if the device sharing media and/or data is in the extended family group.

A team group is an example of a small business application. A company can define a team which includes multiple company devices, accessing their resources from different locations. Some examples are the ability to print, fax, and file sharing without having to setup a specific VPN or operate remote access servers. A team group is a variant on the family group, with enhanced policies.

By creating device groupings, a user may implement policies which allow a single device to be member of multiple overlapping or disjoint groups. A device's policy is a union of the policies of all the groups to which they are a member. In various embodiments, the NEG 105 may be configured to manage groups and policies as defined by a user via the captive portal when services are setup.

In one example, a location may include three groups: Guests, Restricted, and Open. A guest group policy may define that devices in the guest group may be granted access the internet, but nothing else. A restricted group policy may define that devices which are subject to unique applications, possibly restricting where and when they can connect to a user's services. In some examples, a device in the restricted group may be configured to have access to any of the shared equipment at the location including printers, file servers, etc., while blocking access to certain resources. For example, a kids group may be a restricted group, in which certain applications and/or services are blocked from being accessed by kids devices. An open group policy may be defined to give devices unrestricted access to the internet at any time. Also, they have unrestricted access to all the equipment at the location including printers, file servers, etc. This may, in some examples, be used as the default policy for authorized devices in the premise. In some examples, when a restricted group and open group have access to a common resource, members of the open and restricted group may be allowed to communicate with each other, while members of the guest group may be kept isolated. In some embodiments, the difference between the restricted and open group may be WRT access from outside of a physical location.

In some embodiments, not all devices may be configured to support VLAN. In some further embodiments, VLAN may not be assigned automatically to a specific device. Thus, while in some embodiments, groups may be managed via an NEG by assignment of respective VLANs, in other embodiments, VLANs may not be used to separate traffic within a given location. As a result, in some examples, traffic to different groups or devices may be separated by putting groups onto different respective SSIDs. In some embodiment, this may allow a respective location to partition its network such that devices on one SSID cannot easily talk to devices on a different SSID. In some further embodiments, to further isolate, an EoIP/L2 tunnel may be established from each SSID to the NEG 105, thus maintaining separation.

Accordingly, in various embodiments, the NEG 105 may be configured to assign VLANs to effectively identify a respective physical premises/location. The access network (e.g., the ONT/DPU 145, OLT 140, and BNG/L3 switch 135) connecting to the premise, may apply one or more tags to identify the port on which the traffic is arriving at the respective DPU 145a-145b. The VLAN tagged packets may then be forwarded into a respective EoIP/L2 tunnel to and from the NEG 105. In this model, the NEG uses the combination of the EoIP/L2 tunnel source and the tag to identify the location of the access network and the port of arrival. This allows the NEG 105 to notify the network of the device arrival and where, allowing the network to modify the network policy as necessary to provide the device with its desired service.

In some further embodiments, traffic may be separated within a specific location (e.g., a VLAN) by putting different groups of devices into respective subnets (e.g., a range of local IP addresses associated with a VLAN). To that end, it is recommended that unauthorized devices be put into the guest subnet with a short lease. Once the device is authenticated, then it may be assigned a new IP address in a subnet appropriate to the group to which it is assigned, for example, via the NEG 105. Using the example given previously, guests would be in one subnet, while the open and restricted group members may be placed in a different subnet.

In various embodiments, NEG 105 may further be configured to create composable networks. For example, in some embodiments, the NEG 105 may be configured to host the use of distributed resources, including compute resources such as processors (CPU and GPU) and memory assets, storage and networking resources throughout a network. The NEG 105 may further be configured to manage and control the various distributed compute, storage, and networking resources. The resources may be configured to reside throughout the network. For example, in various embodiments, network locations may include, without limitation, a network edge (e.g., customer premise, respective ONT/DPU 145a), deep edge (DSLAM, OLT 140, etc.), metro (Data center 125, COs, Fiber POP, etc.), Core (Core switches, etc.), and Deep (Cloud, Off Net, etc.).

In various embodiments, an advantage enabled by NEG 105 control of resources is the ability to provide the right latency for the right processes and services of a customer/user. For example, OTT services selected by a user, such as voice and video, may require compute resources (e.g., CPU/memory) located at the Edge while other OTT services, such as a Virtual Office, may be better and/or more efficiently handled by resources at the Deep Edge or the Metro. In an enterprise setting, banking functions may rely on Edge/Deep Edge resources, while other processes that run in the background be more efficiently handled by resources at deep locations.

Accordingly, in various embodiments, once the user selects services via the captive portal 325 and an account has been created, the NEG 105, 305 may be configured to ramp-up or otherwise provision one or more of the distributed resources based on a latency policy associated with the selected services. For example, in some embodiments, the NEG 320 may be coupled to one or more respective resource managers, servers, and/or controllers at each respective location and associated with the respective distributed resources at each location. Alternatively, in some embodiments, the NEG 320 may itself include a resource manager service configured to manage each of the distributed resources at each of the locations.

In some examples, each service selected by a user may further be associated with a QoS policy. The QoS policy may indicate, without limitation, a QoS to be enforced for providing a respective service. The QoS policy may further include a latency policy, which may indicate a minimum acceptable latency, range of latencies, or a network location from which one or more distributed resources should be provisioned to provide the respective selected service.

The NEG 105 may, in turn, further be configured to determine the appropriate network location, e.g., the appropriate core network, edge, or deep edge network location at which to ramp-up the appropriate respective distributed resources. In some embodiments, the NEG 105 may be configured to determine that a user device 305 is associated with an existing user account and accessing services previously selected. Accordingly, the NEG 105 may be configured to determine the appropriate network locations associated with the specific location/premises from which the user device 305 is connecting to the network/receiving a respective service. In yet further embodiments, because of an NEG's 105 deployment at a respective data center, each NEG 105 may be associated with a specific network edge, deep edge, core network, and metro network locations. In further embodiments, the NEG 105 may be associated with one or more network edge, deep edge, core, and metro network locations, and respective distributed resources at each of the respective locations. In some embodiments, the NEG 105 may be configured to allow a user to further define their own QoS policy, or to specify specific network locations from which distributed resources should be provisioned/ramped-up by the NEG 105.

To provide the OTT access infrastructure and access to distributed resources, the NEG 105 may be configured to initialize the respective access nodes. Access nodes may include individual DPUs 145, and/or ONTs. In this case, each individual access node may be 802.1x authenticated, and network (DHCP) addresses assigned. Accordingly, in various embodiments, the NEG 105 may be configured to initialize one or more DPUs to provision OTT access and services to respective user devices 160.

In various embodiments, the DPU 145, 310 may include a default configuration for most attributes. In some embodiments, the EoIP/L2 tunnel configuration for each respective DPU 145, 310 may be unique to the DPU 145, 310. Accordingly, in some examples, each DPU 145, 310 may be configured to download its individual configuration as part of its initialization sequence.

For example, in some embodiments, the default configuration of the DPU 145, 310 may be to assign a VLAN-ID to each port of each respective DPU 145, 310. The VLAN assignments may be based on the physical ports of a given DPU 145, 310. Internal to the physical box of the DPU 145, 310 is a virtual SoftGRE tunnel which creates logic “ports”—Endpoint and Transport (GRE-E and GRE-T respectively). In various embodiments, the exact VLAN assignment of a given DPU 145, 310 may be modified. In one example default configuration, the VLAN-ID may be assigned as follows.

Subscriber port 1 (SFP0)
Push VLAN-ID 10 on ingress traffic
Pop tag on egress traffic
Switch in the context of VLAN 10

Subscriber port 2 (SFP1)
Push VLAN-ID 11 on ingress traffic
Pop tag on egress traffic
Switch in the context of VLAN 11

Subscriber port 3 (SFP2)
Push VLAN-ID 12 on ingress traffic
Pop tag on egress traffic
Switch in the context of VLAN 12

Subscriber port 4 (SFP3)
Push VLAN-ID 13 on ingress traffic
Pop tag on egress traffic
Switch in the context of VLAN 13

Subscriber port 5 (SFP4)
Push VLAN-ID 14 on ingress traffic
Pop tag on egress traffic
Switch in the context of VLAN 14

GRE-E Port
This is a tagged port receives traffic from subscriber ports and encapsulates the tagged frame into the EoIP/L2 tunnel. It will not be complete and active until its source and destination IP addresses and bound VLAN are assigned by the downloaded configuration file.
For egress frames, it passes them tagged to the port with the matching VLAN

Trunk port
Ingress traffic: traffic is left unmodified and bridged towards either the GRE-T port, the downlink trunk port, or the management host.
Egress traffic: the uplink port always maintains at least 2 egress queues, one for receiving GRE-T and local Management traffic and one for receiving trunk port traffic. These are setup by default. If more than 2 queues are supported, this will allow prioritization of management traffic if desired.

GRE-T Port
This port sends traffic towards the uplink trunk port only. Note that to support the daisy-chain use case, the traffic from the GRE-T port is always placed into a distinct queue separate from the downlink trunk traffic, on the uplink.

In various embodiments, each DPU 145, 310 may be 802.1x authenticated by the NEG 105, 320, and assigned an IP address via DHCP by the NEG 105, 320. FIG. 3C is a sequence diagram for DPU authentication 300C. The DPU authentication sequence 300C may include a supplicant 310a (DPU), an authenticator 310b (DPU/OLT), and AAA service 330. In various embodiments, the authentication sequence 300C may be an 802.1x authentication procedure. The authenticator 310b in some examples may be a downstream DPU, such as when DPUs are daisy chained. The authenticator 310b may otherwise be an OLT.

In various embodiments, the supplicant 310a may initiate the authentication sequence by transmitting an extensible authentication protocol over LAN (EAPoL) start frame to the authenticator 310b. The Authenticator 310b may be configured to respond to with an EAP request/identify frame. This may be a request to the supplicant 310a to provide an identity. The identity may include, an identifier as previously described. The Supplicant 310a may, therefore, respond with an EAP-Response/Identify frame.

Once a response has been received by the authenticator 310b, the authenticator may transmit a RADIUS-Access request to the AAA service 330. The AAA service 330 may be configured to respond with a RADIUS-Access challenge. The Authenticator 310b and supplicant 310a may subsequently exchange one or more EAP-Request Challenge and EAP-Response Challenge packets. For each EAP response challenge, the authenticator 310b may transmit a radius access request to the AAA service 330, which may respond with a radius access response indicating whether the authentication has been accepted or has failed. In the event of a success, the authenticator 310b may transmit an EAP-success packet to the supplicant 310a. In the even of a failure, the authenticator 310b may transmit an EAP-fail packet to the supplicant 310a, which may in turn cause the supplicant to issue an EAPoL-logoff packet, causing the state of the port to return to an unauthorized state.

The next item of interest is how IP addresses are allocated. In various embodiments, the NEG 105, 320 may be configured to assign an IP address to each DPU 145, 310 via DHCP, with the next element upstream expected to insert option 82 circuit ID to identify where the device was when an address is allocated. FIG. 3D is a sequence diagram of a DHCP handshake 300D for DPUs. Thus, the DHCP handshake sequence 300D may be initiated with a DHCP discover message. The DHCP discover message may originate from an upstream DPU (DPU1 310a) or downstream DPU (DPU2 310b). If the DHCP discover message originates from DPU2 310b, DPU1 310a may be configured to insert option 82 circuit ID to identify DPU2 as the device to be assigned the address. If the DHCP discover request originates from DPU1 310a, the OLT 355 may be configured to insert the option 82 circuit ID. Each subsequent upstream element may be configured to pass the option 82 circuit ID further upstream until it reaches the NEG 320.

The NEG 320 may be configured to respond to the DHCP discover message with a DHCP offer w/ trivial file transfer protocol (TFTP) server address and option 82 circuit ID. Each downstream element may forward the DHCP offer to the appropriate DPU 310a, 310b. The DPU 310a, 310b may be configured to respond to the DHCP offer with a DHCP request, with option 82 circuit ID being inserted and passed upstream as previously described. The NEG 320 may then respond with a DHCP ack, TFTP server address, and option 82 circuit ID, which may be transmitted back downstream to the appropriate DPU 310a, 310b.

In this way DPUs 145, 310 may be turned-up and configured to operate in the OTT access framework and distributed NFVI architecture. In various embodiments, DPU 145, 310 daisy-chaining may be a mechanism by which multiple DPU can be connected in cascade, reconfiguring one of the access ports as a trunk port to connect to a sub-tending DPU 145, 310. In this case, the access port facing the DPU has had its type changed to trunk. The DPU 145, 310 may be configured to support 2 sets of priority queues on the uplink port. One is fed by the downlink trunk port, the other by the EoIP/L2 tunnel and local management traffic. WFQ is enabled on the trunk port and the weight of the daisy-chain queue is adjusted relative to the local traffic queue based on the depth of the chain. In this example below, the queues would have equal weight. In the downstream direction, the traffic matching the local EoIP Tunnel has its GRE header removed and is forwarded based on outer VLAN tag to the matching port. Untagged frames not matching the GRE tunnel are forwarded towards the daisy-chain enabled port.

Each DPU 145, 310 in the chain performs the same operation. Thus, all management traffic is in the management VLAN, while all EoIP/L2 tunnel traffic is forwarded untagged upstream or downstream. Since only EoIP/L2 tunnel traffic should be traversing the daisy-chain network untagged, the only untagged broadcast traffic will be ARP packets. All other untagged broadcast may be dropped.

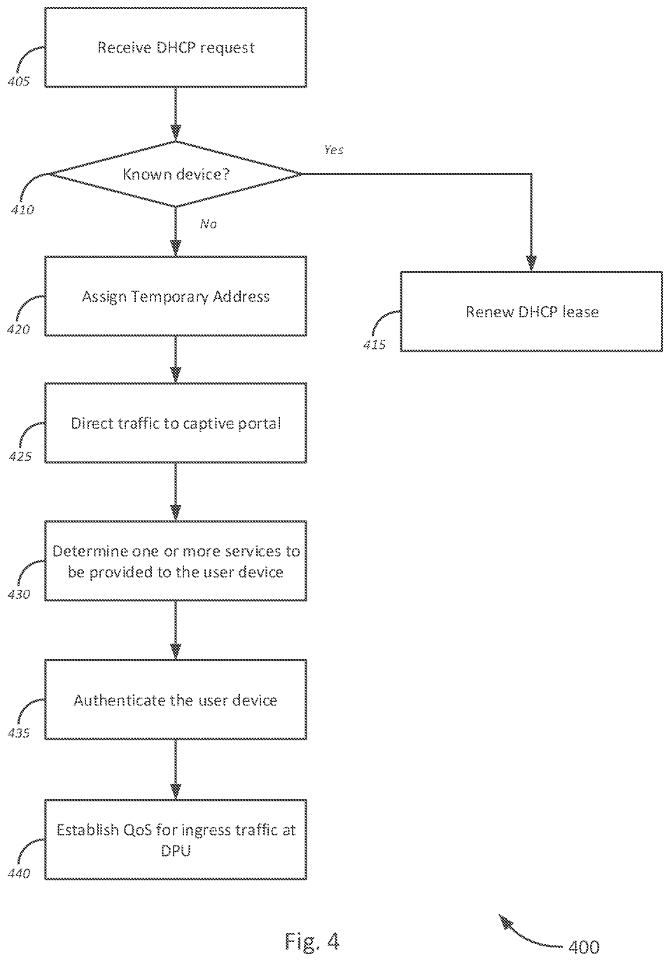

FIG. 4 is a flow diagram of a method 400 for an OTT access framework in a distributed NFVI architecture. The method 400 may begin, at block 405, by receiving a DHCP request. As previously described, in various embodiments, when a user device connects to a network for the first time, the user device may be configured to request an address, such as an IP address, from the NEG. Accordingly, the NEG may be configured to receive a DHCP request from the user device.

At block 410, the NEG may determine whether the device is a known device. In various embodiments, the NEG may receive an identifier from the user device, and send an access request to a AAA service, and/or a AAA server. The AAA server may respond indicating whether access should be granted as it is a known user device, or to redirect the user device to the captive portal. If it is determined that the user device is a known device, the method 400 continues, at block 415, by renewing the DHCP lease of the user device and/or alternatively assigning a new address to the user device.

If it is determined that the device is not a known device, the method 400 continues, at block 420 by assigning a temporary address to the user device. In some embodiments, the temporary address may be a temporary IP address belonging to a guest subnet. At block 425, traffic from the user device may be directed to a captive portal by the NEG. In various embodiments, the user device may be able to login to an existing account through the captive portal, or to activate a new account at the captive portal. The user may further select one or more services to be received via the captive portal. Moreover, one or more devices may be added or otherwise associated with the user account via the captive portal. Accordingly, at block 430, the NEG may determine, via the captive portal, one or more services to be provided to the user device. For example, the NEG may receive an indication of one or more services to provisioned to the user device.

In further embodiments, the NEG may receive an authentication information for the user device from the captive portal or a billing service. At block 435, the method 400 continues by authenticating the user device via the AAA service. Once the user device has been authenticated, the NEG may, at block 440, establish QoS for ingress traffic to the user device via the DPU. In some embodiments, the service selected through the captive portal may indicate a minimum acceptable latency or a range of latencies. For example, in some embodiments, the service may be associated with a service policy, such as a QoS policy and/or latency policy indicative of the minimum acceptable latency or range of latencies associated with the selected service. Accordingly, in some embodiments, the NEG may be configured to notify a policy manager of the selected service and/or to configure a service policy. The NEG and/or policy manager may further send a service policy to a vOLT-M, which may be configured to configure and enforce ingress QoS at an OLT, ONT, and/or the DPU. Thus, in various embodiments, the NEG may establish ingress QoS to be provided to the user device at the DPU.

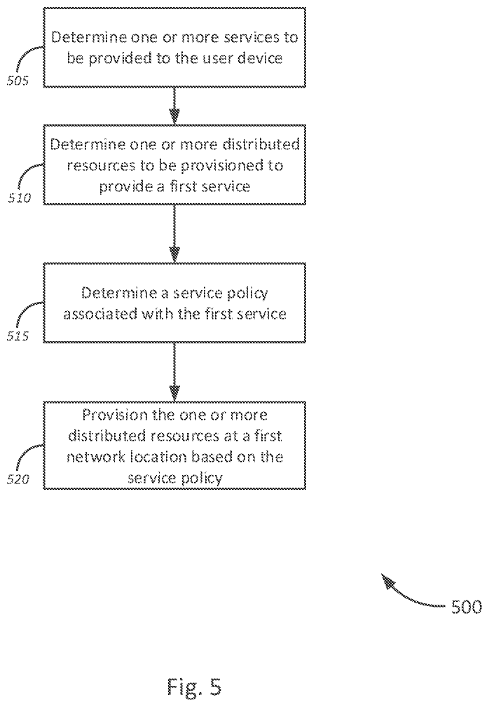

FIG. 5 is a flow diagram of a method for a composable network using distributed NFVI architecture. The method 500 may begin, at block 505, by determining one or more services to be provisioned to the user device. For example, a new user device may select or otherwise configure, via a captive portal, one or more services. Each service may be associated with a service policy and rely on one or more distributed resources to be provisioned. For example, in some embodiments, the NEG may be configured to host and/or manage the use of distributed resources, including compute, storage, and network resources that are located throughout a network. For example, network locations may include, without limitation, at a network edge (e.g., customer premise, respective ONT/DPU 145a), deep edge (DSLAM, OLT, etc.), metro (data center, COs, Fiber POP, etc.), Core (Core switches, etc.), and Deep (Cloud, Off Net, etc.).

Accordingly, in various embodiments, once the user selects services via the captive portal, or an account with existing services is accessed by the user device via the captive portal, the NEG may be configured to determine, at block 510, one or more distributed resources to be provisioned to provide a first service of the one or more services. At block 515, the method 500 may continue by determining a service policy. In some examples, each service selected by a user may further be associated with a QoS policy. The QoS policy may indicate, without limitation, a QoS to be enforced for providing a respective service. The QoS policy may further include a latency policy, which may indicate a minimum acceptable latency, range of latencies, and/or a network location from which one or more distributed resources should be provisioned to provide the respective selected service.

At block 520, the method continues by provisioning the one or more distributed resources at a first network location based on the service policy. For example, the NEG may be configured to ramp-up or otherwise provision one or more of the distributed resources based on a latency policy associated with the selected services. In some embodiments, the NEG may be coupled to one or more respective resource managers, servers, and/or controllers at each respective location and associated with the respective distributed resources at each location. Alternatively, in some embodiments, the NEG may itself include a resource manager service configured to manage each of the distributed resources at each of the locations. The NEG may, in turn, further be configured to determine the appropriate network location, e.g., the appropriate core network, edge, or deep edge network location at which to ramp-up the appropriate respective distributed resources in order to meet the minimum acceptable latency or range of latencies indicated by the service policy/latency policy.

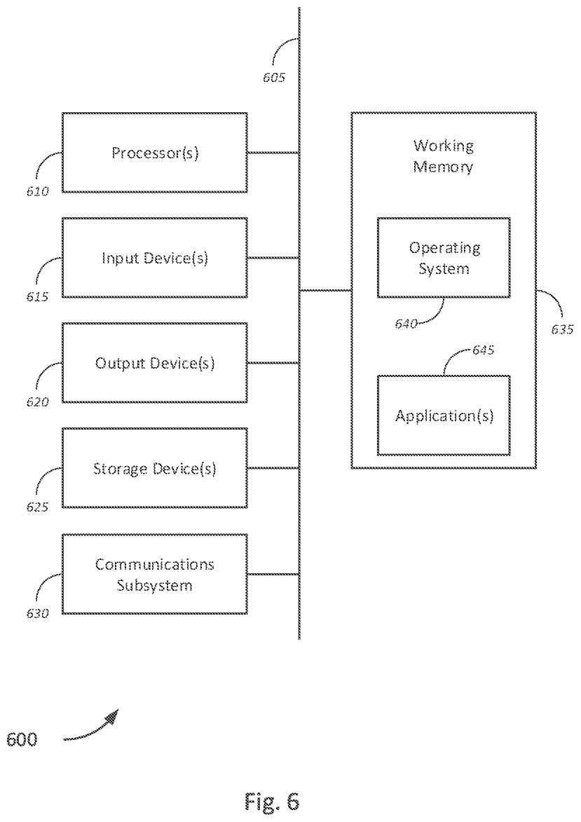

FIG. 6 is a schematic block diagram of a computer system 600 for providing OTT access to network services and distributed NFVI resources, in accordance with various embodiments. FIG. 6 provides a schematic illustration of one embodiment of a computer system 600, such as the NEG, DPU, a virtual RG, network access devices, NIDs, ONTs, OLT, vOLT-M, captive portal host, and user devices, which may perform the methods provided by various other embodiments, as described herein. It should be noted that FIG. 6 only provides a generalized illustration of various components, of which one or more of each may be utilized as appropriate. FIG. 6, therefore, broadly illustrates how individual system elements may be implemented in a relatively separated or relatively more integrated manner.

The computer system 600 includes multiple hardware elements that may be electrically coupled via a bus 605 (or may otherwise be in communication, as appropriate). The hardware elements may include one or more processors 610, including, without limitation, one or more general-purpose processors and/or one or more special-purpose processors (such as microprocessors, digital signal processing chips, graphics acceleration processors, and microcontrollers); one or more input devices 615, which include, without limitation, a mouse, a keyboard, one or more sensors, and/or the like; and one or more output devices 620, which can include, without limitation, a display device, and/or the like.

The computer system 600 may further include (and/or be in communication with) one or more storage devices 625, which can comprise, without limitation, local and/or network accessible storage, and/or can include, without limitation, a disk drive, a drive array, an optical storage device, solid-state storage device such as a random-access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer system 600 might also include a communications subsystem 630, which may include, without limitation, a modem, a network card (wireless or wired), an IR communication device, a wireless communication device and/or chip set (such as a Bluetooth™ device, an 802.11 device, a WiFi device, a WiMax device, a WWAN device, a Z-Wave device, a ZigBee device, cellular communication facilities, etc.), and/or a LP wireless device as previously described. The communications subsystem 630 may permit data to be exchanged with a network (such as the network described below, to name one example), with other computer or hardware systems, between data centers or different cloud platforms, and/or with any other devices described herein. In many embodiments, the computer system 600 further comprises a working memory 635, which can include a RAM or ROM device, as described above.

The computer system 600 also may comprise software elements, shown as being currently located within the working memory 635, including an operating system 640, device drivers, executable libraries, and/or other code, such as one or more application programs 645, which may comprise computer programs provided by various embodiments (including, without limitation, various applications running on the enhanced network gateway as described above), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, flash storage, etc.), and/or provided in an installation package, such that the storage medium can be used to program, configure, and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, single board computers, FPGAs, ASICs, and SoCs) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer system 600) to perform methods in accordance with various embodiments of the invention. According to a set of embodiments, some or all of the procedures of such methods are performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer readable medium, such as one or more of the storage device(s) 625. Merely by way of example, execution of the sequences of instructions contained in the working memory 635 might cause the processor(s) 610 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 600, various computer readable media might be involved in providing instructions/code to processor(s) 610 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 625. Volatile media includes, without limitation, dynamic memory, such as the working memory 635. In some alternative embodiments, a computer readable medium may take the form of transmission media, which includes, without limitation, coaxial cables, copper wire and fiber optics, including the wires that comprise the bus 605, as well as the various components of the communication subsystem 630 (and/or the media by which the communications subsystem 630 provides communication with other devices). In an alternative set of embodiments, transmission media can also take the form of waves (including, without limitation, radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals, and/or the like, are all examples of carrier waves on which instructions can be encoded, in accordance with various embodiments of the invention.

The communications subsystem 630 (and/or components thereof) generally receives the signals, and the bus 605 then might carry the signals (and/or the data, instructions, etc. carried by the signals) to the working memory 635, from which the processor(s) 610 retrieves and executes the instructions. The instructions received by the working memory 635 may optionally be stored on a storage device 625 either before or after execution by the processor(s) 610.

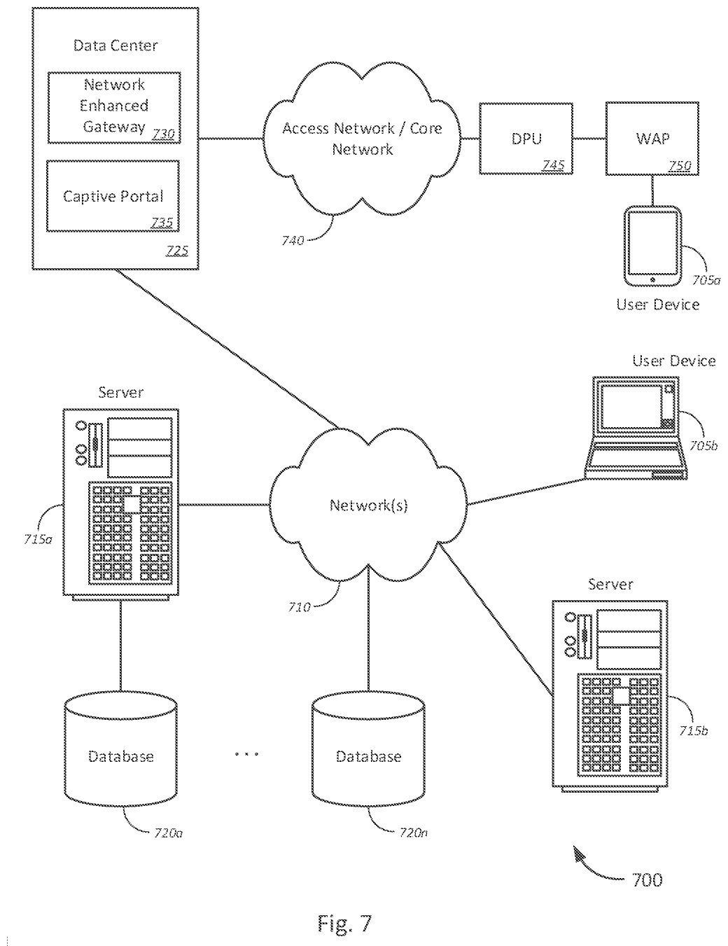

FIG. 7 is a block diagram illustrating a networked system of computing systems, which may be used in accordance with various embodiments. The system 700 may include one or more user devices 705. A user device 705 may include, merely by way of example, desktop computers, single-board computers, tablet computers, laptop computers, handheld computers, and the like, running an appropriate operating system, which in various embodiments may include an ML agent, AI engine, and/or learning API as previously described. User devices 705 may further include external devices, remote devices, servers, and/or workstation computers running any of a variety of operating systems. In some embodiments, the operating systems may include commercially-available UNIX™ or UNIX-like operating systems. A user device 705 may also have any of a variety of applications, including one or more applications configured to perform methods provided by various embodiments, as well as one or more office applications, database client and/or server applications, and/or web browser applications. Alternatively, a user device 705 may include any other electronic device, such as a thin-client computer, Internet-enabled mobile telephone, and/or personal digital assistant, capable of communicating via a network (e.g., the network(s) 710 described below) and/or of displaying and navigating web pages or other types of electronic documents. Although the exemplary system 700 is shown with two user devices 705, any number of user devices 705 may be supported.

Certain embodiments operate in a networked environment, which can include a network(s) 710. The network(s) 710 can be any type of network familiar to those skilled in the art that can support data communications using any of a variety of commercially-available (and/or free or proprietary) protocols, including, without limitation, MQTT, CoAP, AMQP, STOMP, DDS, SCADA, XMPP, custom middleware agents, Modbus, BACnet, NCTIP 1213, Bluetooth, Zigbee/Z-wave, TCP/IP, SNA™ IPX™, AppleTalk™, and the like. Merely by way of example, the network(s) 710 can each include a local area network (“LAN”), including, without limitation, a fiber network, an Ethernet network, a Token-Ring™ network and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, management network, and/or the Internet.

Embodiments can also include one or more server computers 715. Each of the server computers 715 may be configured with an operating system, including, without limitation, any of those discussed above, as well as any commercially (or freely) available server operating systems. Each of the servers 715 may also be running one or more applications, which can be configured to provide services to one or more clients 705 and/or other servers 715.

Merely by way of example, one of the servers 715 might be a data server, a web server, a cloud computing device(s), or the like, as described above. The data server might include (or be in communication with) a web server, which can be used, merely by way of example, to process requests for web pages or other electronic documents from user computers 705. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 705 to perform methods of the invention.

The server computers 715, in some embodiments, might include one or more application servers, which can be configured with one or more applications, programs, web-based services, or other network resources accessible by a client. Merely by way of example, the server(s) 715 can be one or more general purpose computers capable of executing programs or scripts in response to the user computers 705 and/or other servers 715, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 705 and/or another server 715. In some embodiments, an application server can perform one or more of the processes for implementing media content streaming or playback, and, more particularly, to methods, systems, and apparatuses for implementing video tuning and wireless video communication using a single device in which these functionalities are integrated, as described in detail above. Data provided by an application server may be formatted as one or more web pages (comprising HTML, JavaScript, etc., for example) and/or may be forwarded to a user computer 705 via a web server (as described above, for example). Similarly, a web server might receive web page requests and/or input data from a user computer 705 and/or forward the web page requests and/or input data to an application server. In some cases, a web server may be integrated with an application server.

In accordance with further embodiments, one or more servers 715 can function as a file server and/or can include one or more of the files (e.g., application code, data files, etc.) necessary to implement various disclosed methods, incorporated by an application running on a user computer 705 and/or another server 715. Alternatively, as those skilled in the art will appreciate, a file server can include all necessary files, allowing such an application to be invoked remotely by a user computer, user device, or customer device 705 and/or server 715.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 720a-720n (collectively, “databases 720”). The location of each of the databases 720 is discretionary: merely by way of example, a database 720a might reside on a storage medium local to (and/or resident in) a server 715a (or alternatively, user device 705). Alternatively, a database 720n can be remote from any or all of the computers so long as it can be in communication (e.g., via the network 710) with one or more of these. In a particular set of embodiments, a database 720 can reside in a storage-area network (“SAN”) familiar to those skilled in the art. (Likewise, any necessary files for performing the functions attributed to the computers can be stored locally on the respective computer and/or remotely, as appropriate.) In one set of embodiments, the database 720 may be a relational database configured to host one or more data lakes collected from various data sources, user devices 705, or other sources. Relational databases may include, for example, an Oracle database, that is adapted to store, update, and retrieve data in response to SQL-formatted commands. The database might be controlled and/or maintained by a database server.

The system 700 may further include a data center 725, NEG 730, captive portal 735, access network/core network 740, DPU 745, and WAP 750. In various embodiments, the data center 725 may include the NEG 730 and captive portal 735. The NEG 730 may be coupled, via the access network/core network 740, to the DPU 745, which may in turn be coupled to the WAP 750. The user device 705a may in turn, be coupled to the NEG 730 via the WAP 750.

As previously described, in various embodiments, the NEG 730 may receive, from the user device, a request for an address, such as an IP address. Accordingly, in some examples, the request may include, without limitation, a DHCP request from the user device. The NEG 730 may determine whether the device is a known device. In various embodiments, the NEG 740 may receive an identifier from the user device, and send an access request to a AAA service, and/or a AAA server. The AAA server may respond indicating whether access should be granted as it is a known user device, or to redirect the user device to the captive portal 735.

If it is determined that the user device is a known device, the NEG 730 may renew the DHCP lease of the user device and/or alternatively assign a new address to the user device 705a, allowing the user device 705a to access the Internet. If it is determined that the user device 705a is not a known device, the user device 705a may be assigned a temporary address belonging to a guest subnet and limited to the captive portal 735.

At the captive portal 735, the user device 705a may be able to login to an existing account, or to activate a new account. The user may further select, via the captive portal 735, one or more services to be received at the user device 705a. Moreover, one or more devices may be added or otherwise associated with the user account via the captive portal 735. For example, one or more other user devices, such as user device 705b, may be added to the user account.

The NEG 730 may then determine, via the captive portal 735, one or more services to be provided to the user device. For example, in some embodiments, the NEG 730 may receive an indication of one or more services to provisioned to the user device 705a. The NEG 730 may receive authentication information for the user device 705a from the captive portal 735 and authenticate the user device 705a via an authentication server and/or AAA service. Once the user device 705a has been authenticated, the NEG 730 may establish QoS for ingress traffic to the user device 705a via the DPU 745. In some embodiments, the service selected through the captive portal may include an indication of a minimum acceptable latency or a range of latencies. For example, in some embodiments, the service may be associated with a service policy, such as a QoS policy and/or latency policy indicative of the minimum acceptable latency or range of latencies associated with the selected service. Accordingly, in some embodiments, the NEG 730 may be configured to indicate, to a policy manager, the selected service and associated service policy. In some embodiments, the NEG 730 may be configured to create, at the policy manager, the service policy, which may in turn be applied by the NEG 730 and/or policy manager. For example, the NEG 730 and/or policy manager may further send a service policy to a vOLT-M, which may be configured to configure and enforce ingress QoS at an OLT, ONT, and/or the DPU 745. Thus, in various embodiments, the NEG 730 may establish ingress QoS to be provided to the user device at the DPU 745.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to certain structural and/or functional components for ease of description, methods provided by various embodiments are not limited to any single structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in sequentially for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a specific structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to one embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

1. A system comprising:
a first user device associated with a first customer;
a distribution point unit;
a layer 3 switch defining a network edge;
a captive portal host located at a central office;
a network enhanced gateway located in the central office, the network enhanced gateway coupled to the layer 3 switch, and the captive portal host,
wherein the distribution point unit is configured to couple the user device to the layer 3 switch, wherein the layer 3 switch is configured to couple the distribution point unit to the network enhanced gateway,
wherein the network enhanced gateway comprises:
a processor; and
non-transitory computer readable media comprising instructions executable by the processor to:
receive, via the layer 3 switch, a request for an internet protocol address from the user device;
determine whether the user device is a known device;
assign a first internet protocol address to the user device;
direct user packets from the user device to the captive portal host;
determine, via the captive portal host, one or more services to be provided to the user device, wherein the one or more services includes internet service at a contracted speed;
authenticate, via an authentication, authorization, and accounting service, the user device;
establish, via a policy manager, quality of service for ingress traffic to the user device at the distribution point unit according to the contracted service speed;
determine, for a first service of the one or more services, a first set of one or more distributed resources to be provisioned to provide the first service of the one or more services;
determine a service policy associated with the first service, the service policy indicative of a minimum acceptable latency for providing the first service;
determine a first network location at which the respective set of one or more distributed resources should be provisioned to provide the first service at the minimum acceptable latency; and
provision the first set of one or more distributed resources at the first network location determined for the first service.

2. (canceled)

3. The system of claim 1, wherein the first network location includes one or more of the network edge, deep edge, metro network, core network, and deep network locations, wherein provisioning the first set of one or more distributed resources includes provisioning the first set of one or more compute resources at at least one of the network edge, deep edge, metro network, core network, and deep network.

4. The system of claim 1, wherein the first network location at which the first set of one or more distributed resources is provisioned is based, at least in part, on a customer selection of a desired latency.

5. The system of claim 1, wherein the instructions are further executable by the processor to:
determine, via the captive portal, a user account to be associated with the user device; and
register, with the authentication, authorization, and accounting service, the user device with the user account.

6. The system of claim 1, wherein the instructions are further executable by the processor to:
determine, via the captive portal, a group to be assigned to the user device;
determine, via the distribution point unit, a subnet to be assigned to the group; and
assign, via the distribution point unit, a second internet protocol address in the subnet to the user device.

7. The system of claim 6, wherein the group to be assigned to the user device is determined based on a login provided to the authentication, authorization, and accounting service, wherein the login is associated with a user account of the user device, and wherein the login is indicative of the group to be assigned to the user device.

8. The system of claim 6, wherein the instructions are further executable by the processor to:
determine, via the captive portal, to assign the user device to a guest group, wherein devices in the guest group are assigned addresses in a subset of the subnet, wherein devices in the guest group are restricted from accessing other resources located on the subnet.

9. The system of claim 6, wherein the first internet protocol address is assigned in response to determining that the user device is not known, wherein the first internet protocol address is a temporary address associated with a guest group subnet, wherein the instructions are further executable by the processor to:
assign the second internet protocol address to the user device in response to the user device being authenticated.

10. An apparatus comprising:
a processor;
non-transitory computer readable media comprising instructions executable by the processor to:
receive, via a layer 3 switch, a request for an internet protocol address from a user device;
determine whether the user device is a known device;
assign a first internet protocol address to the user device;
direct user packets from the user device to a captive portal;
determine, via the captive portal, one or more services to be provided to the user device, wherein the one or more services includes internet service at a contracted speed;
authenticate, via an authentication, authorization, and accounting service, the user device;
establish, via a policy manager, quality of service for ingress traffic to the user device at a distribution point unit according to the contracted service speed;
determine, for a first service of the one or more services, a first set of one or more distributed resources to be provisioned to provide the first service of the one or more services;
determine a service policy associated with the first service, the service policy indicative of a minimum acceptable latency for providing the first service;
determine a first network location at which the respective set of one or more distributed resources should be provisioned to provide the first service at the minimum acceptable latency; and
provision the first set of one or more distributed resources at the first network location determined for the first service.

11. (canceled)

12. The apparatus of claim 10, wherein the first network location includes one or more of the network edge, deep edge, metro network, core network, and deep network locations, wherein provisioning the first set of one or more distributed resources includes provisioning the first set of one or more compute resources at at least one of the network edge, deep edge, metro network, core network, and deep network.

13. The apparatus of claim 10, wherein the instructions are further executable by the processor to:
determine, via the captive portal, a user account to be associated with the user device; and
register, with the authentication, authorization, and accounting service, the user device with the user account.

14. The apparatus of claim 10, wherein the instructions are further executable by the processor to:
determine, via the captive portal, a group to be assigned to the user device;
determine, via the distribution point unit, a subnet to be assigned to the group; and
assign, via the distribution point unit, a second internet protocol address in the subnet to the user device.

15. The apparatus of claim 14, wherein the instructions are further executable by the processor to:
determine, via the captive portal, to assign the user device to a guest group, wherein devices in the guest group are assigned addresses in a subset of the subnet, wherein devices in the guest group are restricted from accessing other resources located on the subnet.

16. The apparatus of claim 14, wherein the first internet protocol address is assigned in response to determining that the user device is not known, wherein the first internet protocol address is a temporary address associated with a guest group subnet, wherein the instructions are further executable by the processor to:
assign the second internet protocol address to the user device in response to the user device being authenticated.

17. The apparatus of claim 14, wherein the group to be assigned to the user device is determined based on a login provided to the authentication, authorization, and accounting service, wherein the login is associated with a user account of the user device, and wherein the login is indicative of the group to be assigned to the user device.

18. A method comprising:
receiving, via a layer 3 switch, a request for an internet protocol address from a user device;
determining, via a network enhanced gateway, whether the user device is a known device;
assigning, via the network enhanced gateway, a first internet protocol address to the user device;
directing, via the network enhanced gateway, user packets from the user device to a captive portal;
determining, via the captive portal, one or more services to be provided to the user device, wherein the one or more services includes internet service at a contracted speed;
authenticating, via an authentication, authorization, and accounting service, the user device;
establishing, via a policy manager, quality of service for ingress traffic to the user device at a distribution point unit according to the contracted service speed;
determining, via the network enhanced gateway, for a first service of the one or more services, a first set of one or more distributed resources to be provisioned to provide the first service of the one or more services;
determining, via the network enhanced gateway, a service policy associated with the first service, the service policy indicative of a minimum acceptable latency for providing the first service;
determining, via the network enhanced gateway, a first network location at which the respective set of one or more distributed resources should be provisioned to provide the first service at the minimum acceptable latency; and
provisioning, via the network enhanced gateway, the first set of one or more distributed resources at the first network location determined for the first service.

19. (canceled)

20. The method of claim 18 further comprising:
determining, via the captive portal, a group to be assigned to the user device;
determining, via the distribution point unit, a subnet to be assigned to the group; and
assigning, via the distribution point unit, a second internet protocol address in the subnet to the user device.
